(19) United States
(12) Patent Application Publication
(10) Pub. No.: US 2004/0190749 A1
(43) Pub. Date: Sep. 30, 2004

(54) Method for countering rotation attacks in a video watermark system

(76) Inventors: Peng Xu, San Jose, CA (US); Dwight David Griffin, San Jose, CA (US); Jun Hirai, Tokyo (JP)

Correspondence Address: WAGNER, MURABITO & HAO LLP, Third Floor, Two North Market Street, San Jose, CA, 95113, US

(21) Appl. No.: 10/402,732

(22) Filed: Mar. 28, 2003

(51) Int. Cl. G06K 9/00

(52) U.S. Cl. 382/100

(57) ABSTRACT

A method of detecting a watermark embedded in a rotated video field is disclosed. The method entails correlating two video tiles in the rotated video field to find relative positions of a watermark. An estimation of an angle of rotation of the video field is performed based on the relative positions of the watermark. The angle of rotation in the rotated video field is estimated by selecting a pair of video tiles, determining a magnitude of a shift in one tile of the pair relative to the other, and calculating the angle of rotation based on the magnitude of the shift and a pre-known width of the video tiles. An expected watermark pattern is then rotated by the estimated angle of rotation, and the rotated expected watermark pattern is used as input to a Symmetric Phase Only Match Filter (SPOMF) system for watermark detection.

### BACKGROUND OF THE INVENTION

1. Field of the Invention

Embodiments of the present invention relate to the field of watermarking video systems. More particularly, embodiments of the present invention relate to a method for detecting rotation attacks in a video that has a Symmetric Phase Only Match Filter (SPOMF) watermark method of detection.

2. Related Art

With the increase in the use and distribution of digital multimedia data, content protection becomes increasingly important to avoid unrestricted duplication and dissemination of copyrighted materials. Digital watermark technology has emerged as a method complementary to encryption for content protection of copyrighted materials. Encryption can protect the data during the transmission from the sender to the receiver. Once the receiver has received the data and decrypted the data for further processing and interpreting, the data is the same as the original one and is no longer protected. Digital watermarking techniques embed a secret imperceptible signal, a watermark, into the original content. It always remains present with the original content and survives transformation, conversion and transcoding, even when digital content is converted into the analog domain.

Therefore, digital watermarking has become a very promising technique that can be used in a variety of areas for the following purposes: 1) copyright protection: the data owner can embed a watermark representing copyright information in his data, and prove his ownership using the watermark; 2) fingerprinting: the owner can embed different watermarks in the copies of data that are sold to different consumers, and identify consumers who have broken their license agreements using the watermarks; 3) copy protection: the information derived from the watermark can control digital playing and recording devices; 4) data authentication: a fragile watermark can indicate whether the data has been attacked and provide the location where the data was altered; 5) data hiding: secret private messages can be transmitted using watermark techniques.

Watermark systems should meet some basic requirements in order to be effective systems. The watermark needs to be invisible and difficult to remove. Detection of the watermark should be fast to run in real-time, inexpensive to implement, and robust to common processing and transformation. The probability of a false positive (positive detection at a place where there is no watermark) should be extremely low. The information stored in the watermark, called a payload, must have a sufficient number of bits to support the information requirements of the applications. The watermark technique used needs to be secure. Based on Kerckhoff's assumption about security, one should assume that the method used to encrypt data is known to an unauthorized party and the security must lie in the choice of a key. A watermarking technique is truly secure only if knowing the exact algorithm for embedding and extracting the watermark does not help an unauthorized party to detect the presence of the watermark or remove it.

One current watermark system for video applications is based on the Symmetric Phase Only Match Filter (SPOMF) method. The SPOMF method balances the basic requirements for video watermark systems and has proven to be efficient and easy to implement. The watermark can be embedded in the video in the base-band or bit stream, (e.g., Motion Picture Experts Group (MPEG)) domains, and detected in base-band video or converted bit stream domain, such as partially decoded MPEG video. FIG. 1 is a logical block diagram illustrating a conventional watermark-embedding scheme. The basic watermark pattern w₀ 102 is simply a Gaussian noise pattern. Each watermark tile w(K) 103 is a small matrix of n*n pixels that contains two copies of the same pattern where one is shifted relative to the other. The shift vector is determined by the payload of the watermark K 101. In order to be shift invariant, watermark W(K) 105 has translation symmetry, formed by tiling the watermark tile w(K) 103 over the extent of the video image. FIG. 2 illustrates a single watermark tile w(K) 103 and an entire watermark W(K) 105 in accordance with a conventional SPOMF system.

The watermark is embedded repeatedly in every field of the video in the spatial domain so that the temporal axis in the video can be used during detection. On each field, embedding is performed as on a still image, and the embedding strength of the watermark is adapted to the luminance changes in the image. The embedding strength is small in image regions where there is little activity and large in regions where there is much activity so that the watermark becomes less perceptible. Referring again to FIG. 1, a Laplacian high-pass filter λ is used to generate the local scaling factor λ(X) 108. The embedding strength is also adjusted by a global factor S 106. Eventually the watermarked image Y 109 is obtained by the following relationship:

Y=X+S×λ(X)×W(K). (1)

The watermark detection is performed by spatial correlation. An exhaustive search for the correct alignment of the watermark in the image is needed over all possible spatial shifts. However, because of the translation symmetry in the watermark, the search only needs to be performed over all possible cyclic shifts on the tile B 310 (n*n pixels) folded across the images over a period of time (typically 60 fields or one second of video). The folding of the image is like the reverse of tiling in that the tiles are “cut” from the image, stacked and summed together. FIG. 3A is a diagram 300a illustrating the folding of watermark tiles 103 across an image 109 to obtain a folded tile from one field. Folded tiles from multiple fields are summed over a period of time to obtain a total folded tile B 310. The correlation over all possible cyclic shifts is equivalent to a two-dimensional cyclic convolution that can be efficiently computed in the frequency domain by the following relationship:

D=IFFT(FFT(B)×FFT(w₀)*), (2)

where B 310 is the folded tile from the video and w₀ 102 is the basic watermark pattern. The performance can be improved by preceding the correlation with matched filtering. The goal of matched filtering is to de-correlate the suspect image Y 109 to obtain an approximately spectrally white version of Y 109. By only retaining the phases of B 310 we obtain a purely white signal, which is equivalent to the matched filter in the spatial domain. Experimentally, the best detection is obtained by also ignoring the magnitude information in w₀ 102, resulting in the following detection relationship:

D=IFFT(phase(FFT(B))×phase(FFT(w₀)*)). (3)

FIG. 3B illustrates correlation data 300b from the correlation between the basic watermark pattern w₀ 102 and the folded tile B 310. This is referred to as the SPOMF method. The highest peak 320 in the resulting matrix of correlation data D will indicate the strength of the embedded watermark in Y 109, and the payload K 101 can be decoded from the vector 325 between the first peak 320 and the second peak 330

FIG. 4 shows the watermark detection scheme. The watermarked image 109 is folded and accumulated to obtain image tile B 310. Then, using the SPOMF method 410 the expected basic watermark pattern w₀ 102 is used to find a match with correlation data D 300b and payload K 101 can be decoded.

The SPOMF system can also be employed to detect spatial scaling of the video, and the derived scale can be fed back to re-scale the folded video for scale-resistant watermark detection. The current SPOMF system cannot, however, deal with rotation attacks very well. The correlation peaks (e.g., peaks 320 and 330 of FIG. 3B) drop dramatically when video is rotated even by a small angle. Therefore the watermark protection could possibly be overcome through rotating the video through a small, perhaps visually imperceptible angle.

Therefore, a need exists for a method to counter rotation attacks in video watermark systems that use the SPOMF method of inserting and detecting watermarks.

### SUMMARY OF THE INVENTION

Embodiments of the present invention provide a method and system for countering rotation attacks in video watermark systems that use the SPOMF method of detecting watermarks. Thereby, the possibility of overcoming watermark protection via image rotation in a SPOMF insertion and detection system can be eliminated.

Specifically, one embodiment of the present invention provides a method of detecting a watermark embedded in a rotated video field. The method entails correlating two video tiles in the rotated video field to find relative positions of a watermark. Importantly, an estimation of an angle of rotation of the video field is performed based on the relative positions of the watermark. An expected watermark pattern is then rotated by the estimated angle of rotation, and the rotated expected watermark pattern is used as input to a Symmetric Phase Only Match Filter (SPOMF) system for watermark detection. In this manner, embodiments routinely detect the rotational watermark in the rotated image. Therefore, watermarking can be used to protect the video content even if the image is rotated by a small angle, e.g., less than 10 degrees.

The method for estimating the angle of rotation in the rotated video field entails selecting a pair of video tiles, determining a magnitude of a shift in one tile of the pair relative to the other, and calculating the angle of rotation based on the magnitude of the shift and a pre-known width of the video tiles.

The method can be performed using two in-line tiles that are horizontally in-line, in which case the measured shift will be vertical. The method can also be performed with two in-line tiles that are vertically in-line, determining the magnitude of the horizontal shift. The rotating of the watermark pattern can be performed in the spatial domain or in the frequency domain and the detection of the watermark can be performed in base-band video or in converted bit stream (e.g., partially decoded MPEG) video.

Embodiments of the present invention cover a general method that can recover the rotation angle of rotated video embedded with a translation-symmetric watermark. Other embodiments use the rotation angle effectively to detect the watermark in the rotated video. In one example, folding is used at the same location over a period of time rather than the conventional method previously used in the system. This gives a significant improvement of detection. Two exemplary embodiments are described for rotating the watermark in either the spatial domain or the frequency domain. Because the SPOMF is operated in the frequency domain, the implementation in the frequency domain appears to be the preferred embodiment.

### BRIEF DESCRIPTION OF THE DRAWINGS

The accompanying drawings, which are incorporated in and form a part of this specification, illustrate embodiments of the invention and, together with the description, serve to explain the principles of the invention:

Prior Art FIG. 1 is a logical block diagram illustrating a conventional watermark-embedding scheme.

Prior Art FIG. 2 illustrates a single watermark tile and an entire watermark in accordance with a conventional SPOMF system.

Prior Art FIG. 3A is a diagram illustrating the SPOMF method of folding watermark tiles across an image to obtain a folded tile.

Prior Art FIG. 3B illustrates correlation data from a correlation between a basic watermark pattern and a folded tile using the SPOMF method.

Prior Art FIG. 4 shows a watermark detection scheme in accordance with the conventional SPOMF system methodology.

FIG. 5 is a flow diagram of a process for detecting a watermark in a rotated video stream or image in accordance with one embodiment of the present invention.

FIG. 6 is a flow diagram of a process for estimating an angle of rotation in a video field in accordance with one embodiment of the present invention.

FIG. 7A illustrates a single watermark tile containing an expected watermark pattern.

FIG. 7B illustrates a method for estimating the angle of rotation in a rotated video, according to one embodiment of the present invention.

FIG. 8 depicts a block diagram of an exemplary DVD with a bit stream (MPEG) inserter/detector upon which an embodiment of the present invention may be practiced.

FIG. 9 depicts a block diagram of an exemplary DVD with a baseband inserter/detector upon which an embodiment of the present invention may be practiced.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

The conventional SPOMF system cannot deal well with rotation attacks, e.g., attempts to avert watermark detection by rotating a video broadcast an imperceptible amount. The correlation peaks of the conventional watermark pattern drop dramatically when the video is rotated even by a small degree, thereby rendering ineffective the copy protection. However, in one embodiment of the present invention it is shown that, if the watermark pattern used for the correlation is rotated by the same angle as the video rotation, the correlation peaks are still high enough to be detected and provide good copy protection, even in the case of a rotated video. Therefore, the first step is to estimate the rotation in the video. The translation symmetry in the watermark embedded in the video remains present even though the video is rotated. The coordinate of the translation symmetry is rotated in the same way as the video is rotated. Therefore, two horizontally in-line or two vertically in-line tiles can be correlated to find the relative positions of the watermarks in the pair.

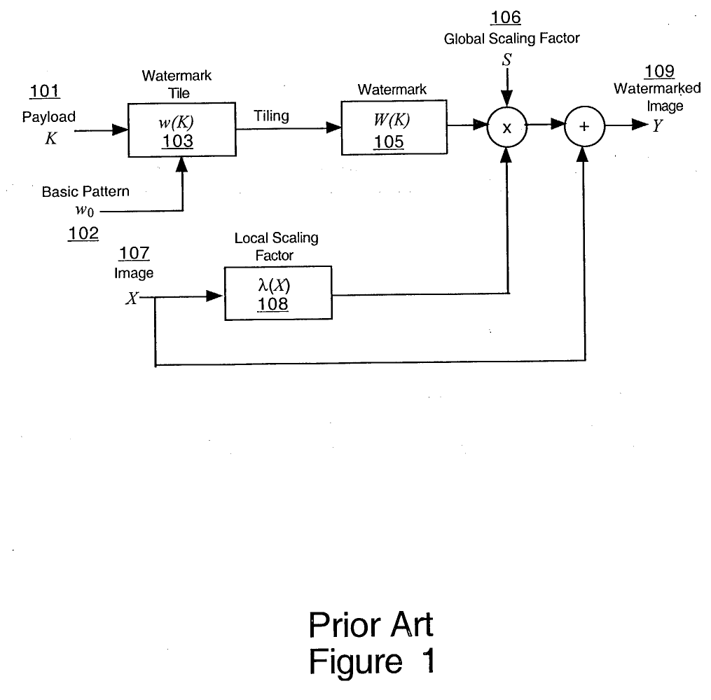

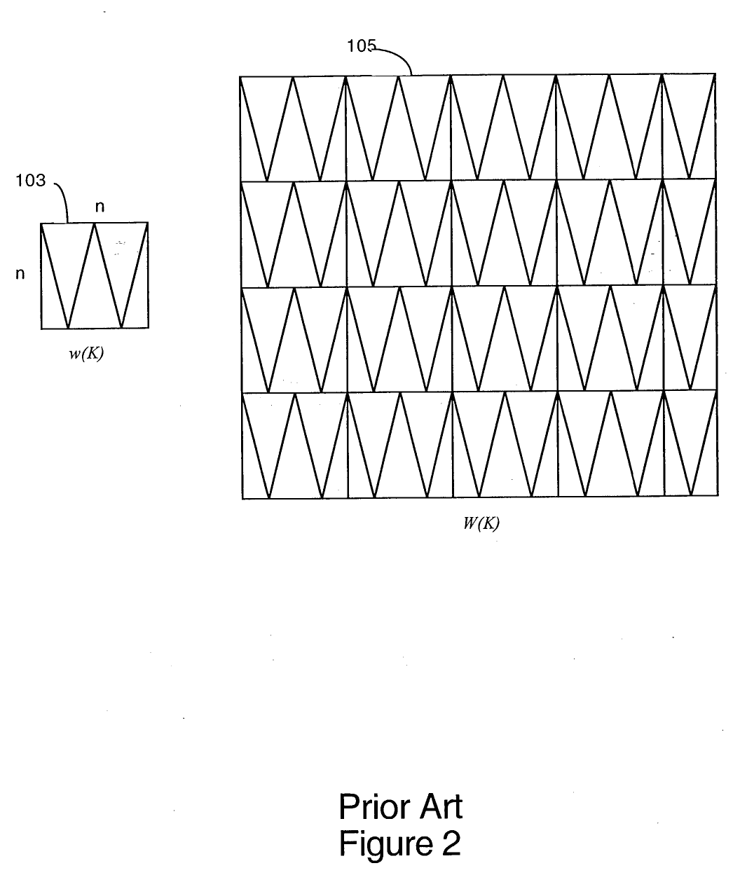

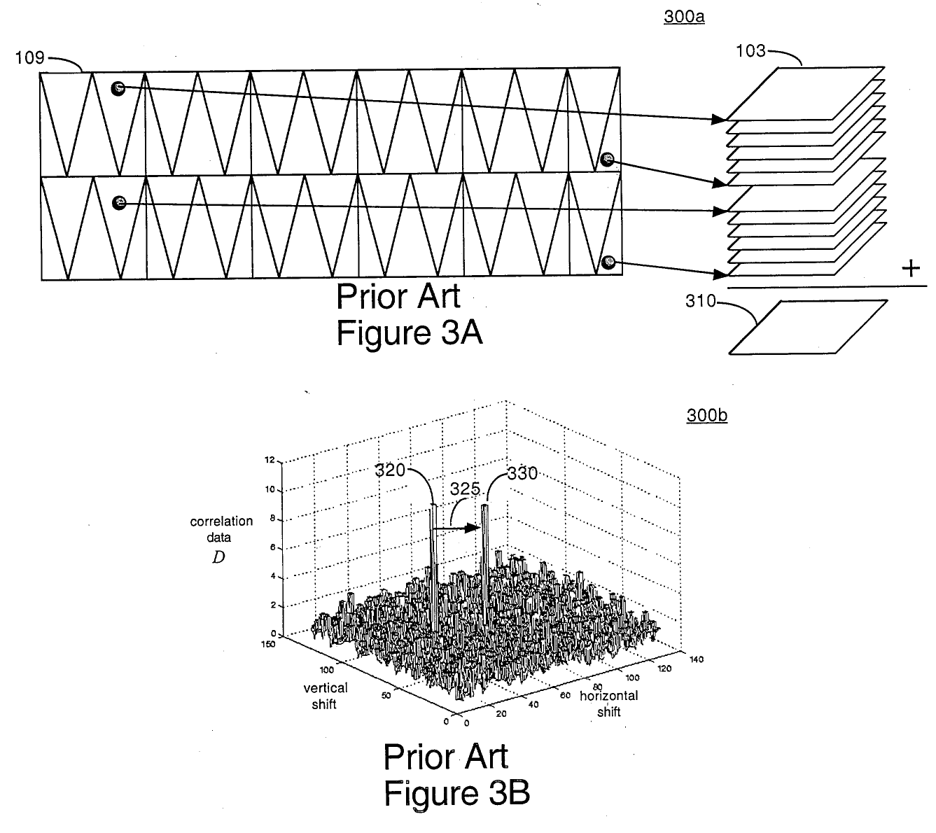

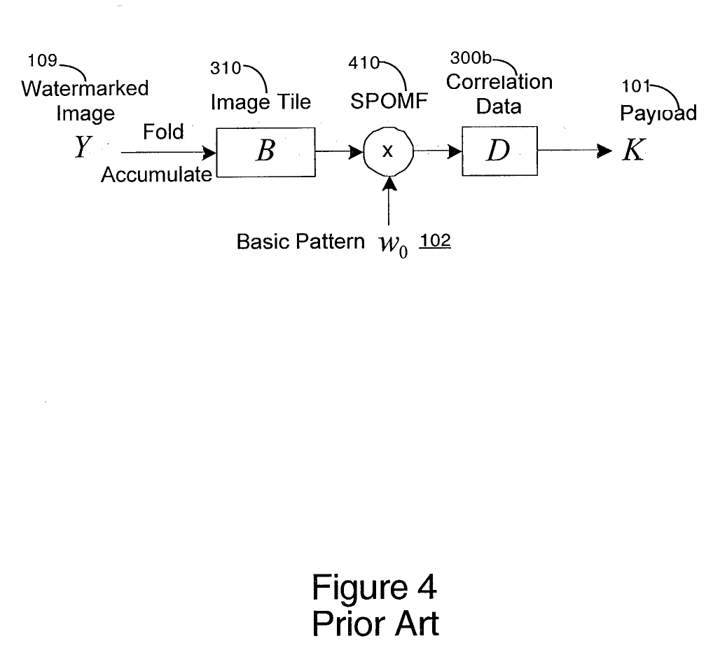

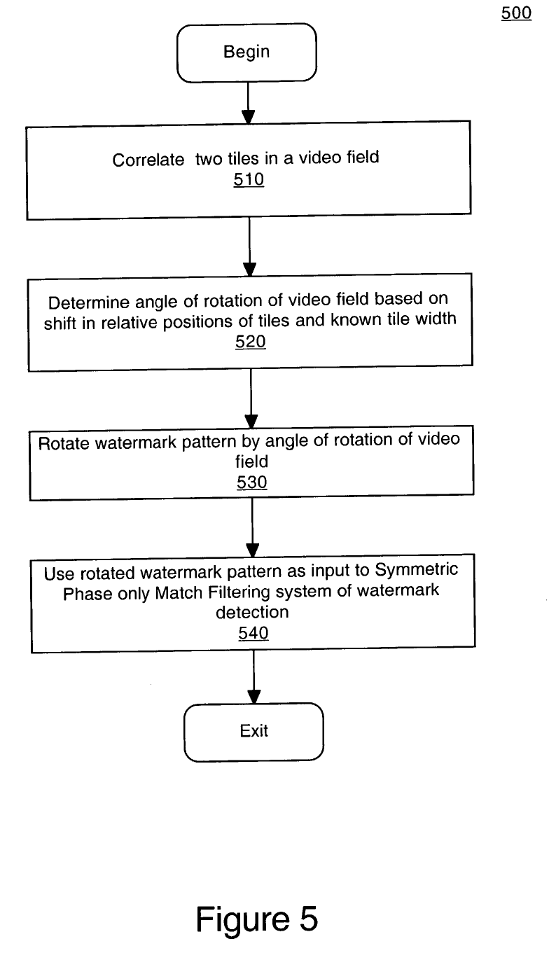

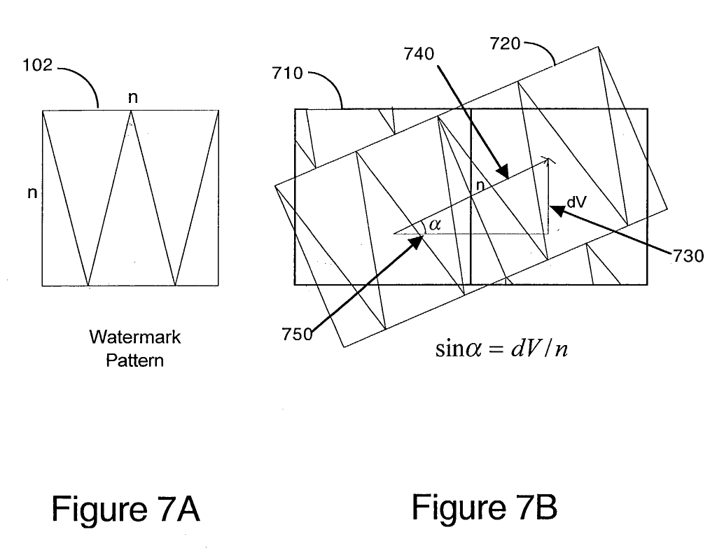

Refer now to FIG. 5 for a flow diagram 500 of a process for detecting a watermark in a rotated video, in accordance with one embodiment of the present invention. Process 500 may be implemented in hardware, by digital components or may be implemented as computer instructions executed by a computer system. FIGS. 7A and 7B illustrate diagrams involved in the method for estimating the angle of rotation in a rotated video, according to one embodiment of the present invention. These three figures will be discussed in concert to illustrate one embodiment of the present invention.

In process 500 it is assumed that a video player device is receiving or playing a video program and concurrently performing a watermark check thereof. In step 510 of FIG. 5, two in-line tiles in a video field are correlated in accordance with one embodiment of the present invention. FIG. 7A shows a single watermark tile 102 of dimensions n×n, containing the expected watermark pattern. The pattern shown is exemplary. FIG. 7B illustrates two horizontally adjacent in-line tiles 710 with rotated video. Although the selected tiles are shown to be adjacent tiles that are in-line at their respective centers, it should be understood that any pair of tiles can be used, although the actual calculation details would change based on the geometric relationship of the two tiles. The relative difference in position of the embedded watermarks in any pair of tiles from rotated video as compared to unrotated video can be used to derive the angle of rotation. The calculation would need to be adjusted based on the geometric relationship of the two tiles and the expected relative shift of the embedded watermarks in those two tiles.

Two previously horizontally adjacent tiles 720 with properly aligned watermarks are shown overlaying the tiles 710 to illustrate the rotated angle of the video and the watermark pattern, illustrating the presence of translation symmetry in the watermark, even in the rotated video. In FIG. 7B it is assumed that the video program has been rotated by this rotated angle alpha (α).

A “best match” correlation of the in-line tiles 710 is performed by conducting a search for the correlation peak between the pair using the SPOMF method in one embodiment. Since rotation attacks would be practically limited in a small range (<10 degrees) due to viewing-tolerance, the relative shifting of one tile to the other is limited and this limits the area to search for the correlation peak in the correlation result matrix. Therefore, in this reduced range the result is more accurate and not heavily influenced by noise.

For the pair of in-line tiles 710, the watermark in one tile appears shifted vertically relative to the other. The magnitude of this vertical shift can be measured and used to determine the angle of rotation of the video field. Although the two in-line tiles 710 are shown as horizontally in-line, the same correlation method can be employed for vertically in-line tiles or for diagonally adjacent tiles having the embedded watermark in the same relative position.

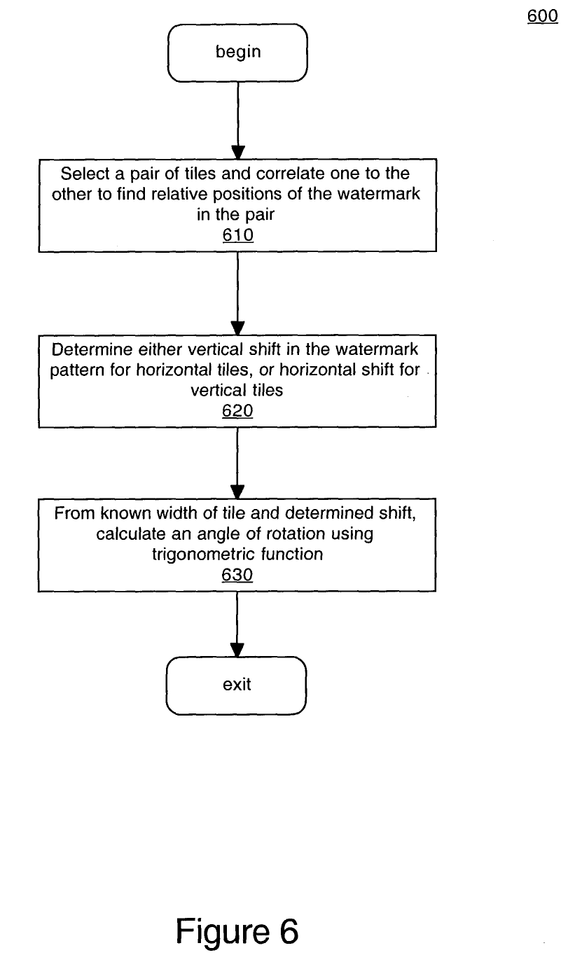

In step 520 of process 500, the angle of rotation of the video field is automatically estimated from the magnitude of the shift and the known width n 740 of the watermark tile 102, in accordance with one embodiment of the present invention. The rotated angle estimation is discussed further in conjunction with FIG. 6. In an instance where two vertically in-line tiles may have been used for the correlation, the shift would be in a horizontal direction. In the illustration of FIG. 7B, horizontally in-line tiles 710 have a vertical shift dV 730.

At step 530 of FIG. 5, the watermark pattern 102 can be rotated by the estimated angle of rotation of the video field. Then, according to one embodiment of the present invention, at step 540 the rotated watermark pattern is input to the SPOMF watermark detection system as shown by the following relationship;

D=IFFT(phase(FFT(B))×phase(FFT(R(w₀))*)), (4)

where D is the correlation, B is the folded tile and R (w₀) is the rotated pattern. The fold and accumulation is different for the SPOMF in a rotated watermark detection than that of the conventional SPOMF system, in that the accumulation is performed for one tile per field, at the same location in the field. The correlation peaks give the detection results of the watermark. At the completion of step 540, process 500 is exited.

The FFT has the characteristic that rotation by an angle α in the spatial domain is equivalent to rotation in the frequency domain by the same degree. Because the SPOMF system is operated in the frequency domain, the rotation of the watermark can be implemented in the frequency domain as shown in the following relationship:

D=IFFT(phase(FFT(B))×phase(R(FFT(w₀))*)), (5)

Results show that, although the detection peaks from the correlation with the watermark rotated in the frequency domain are less than the peaks using the spatially rotated watermark, they are still far above the detection threshold. Therefore the method of the present embodiment may be integrated into the conventional SPOMF based watermark detection system with minimal cost. Table 1 below shows the detection peaks from rotated video using the conventional correlation (see relationship (3) of the background section), the spatial rotation of relationship (4) and the frequency rotation of relationship (5).

TABLE 1

| | Rotation Angle | | | | | |
|---|---|---|---|---|---|---|
| | 1° | 2° | 3° | 4° | 5° | 10° |
| Peak - | 4.13 | 3.77 | 4.11 | 4.48 | 3.56 | 3.94 |
| No rotation | | | | | | |
| Peak - | 15.96 | 22.09 | 27.64 | 16.19 | 30.86 | 14.48 |
| Spatial rotation | | | | | | |
| Peak - | 13.45 | 19.11 | 17.24 | 17.23 | 7.87 | 9.68 |
| Frequency rotation | | | | | | |

FIG. 6 is a flow diagram of the process 600 for estimating an angle of rotation in a rotated video field according to one embodiment of the present invention. Process 600 may be implemented using hardware devices or by software or by a combination of both. In step 610, a pair of selected tiles is correlated, one to the other. At step 620 of FIG. 6, the magnitude of the vertical shift dV 730 is determined for horizontally in-line tiles 710. In the case of vertically in-line tiles, the shift would be in the horizontal direction, dH.

Referring now to step 630 of FIG. 6, knowing the width n 740 of the watermark tile 102, and dV 730, the angle of rotation α 750 can be estimated by arcsin (dV/n). Table 2 shows rotation angles estimated from correlation peaks using arcsin (dV/n) from a pair of horizontally in-line tiles in which n 740 has a value of 128. At the completion of step 630 process 600 is exited.

TABLE 2

Rotation angle

| | 1° | 2° | 3° | 4° | 5° | 10° |
|---|---|---|---|---|---|---|
| Measured | 2 | 4 | 7 | 9 | 11 | 22 |
| dV | | | | | | |
| Derived | 0.90° | 1.79° | 3.13° | 4.03° | 4.93° | 9.90° |
| angle | | | | | | |

Once the estimated rotation angle is derived, the watermark pattern may, according to one embodiment, be rotated by the estimated angle and the rotated pattern R (we) may be used as input for the SPOMF watermark detection as shown in relationships (4) and (5) above. Of course, once the watermark is detected, one or more copy protection functions may be employed.

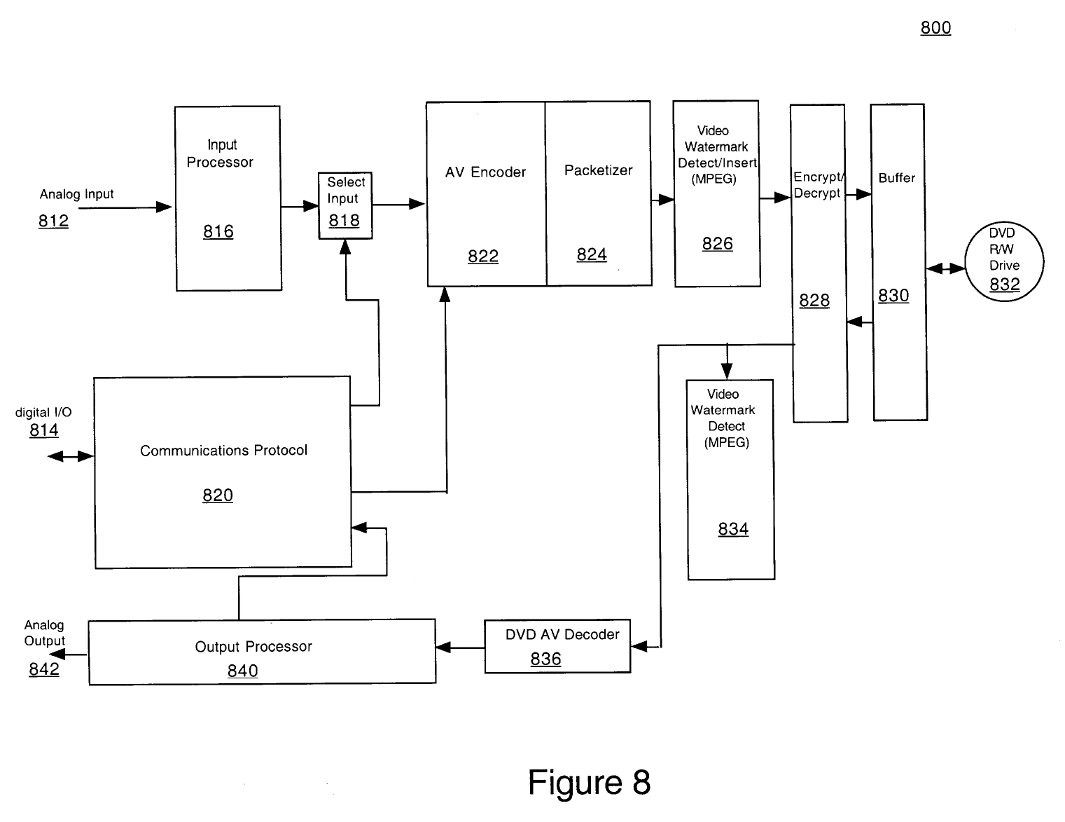

FIG. 8 depicts a block diagram of a simplified exemplary digital versatile disk (DVD) 800 with a Moving Picture Experts Group (MPEG) inserter/detector 826 upon which an embodiment of the present invention may be practiced. Analog input 812 is received by input processor 816 where it is identified and converted into a digital signal. This signal may represent a data stream that is to be written to a DVD disk at DVD drive 832. Alternatively, a digital input signal 814 may be received via a communications protocol 820 that would use a protocol such as MPEG to decode the digital signal prior to its being selected by select input 818.

The digital signal is then directed to AV Encoder 822 by select input 818 that buffers various input signals. At AV Encoder 822, the signal may be encoded and then packetized by packetizer 824. At this point the signal is considered partially encoded as it has not yet been encrypted. The partially encoded signal then enters an MPEG version of watermark detector/inserter 826 where a watermark may be inserted or detected, as appropriate, in accordance with an embodiment of the present invention. The detection of a watermark in a rotated video field as discussed in association with FIGS. 5, 6, 7A and 7B above can be performed at this location and, depending on the payload of the watermark, the signal may be stopped if the watermark indicates that no copies are to be made. The signal, if permitted to continue, is then encrypted by encryptor/decryptor 828 and enters buffer 830 for gaining access to DVD R/W drive 832 for writing to a DVD disk.

Still referring to FIG. 8, a disk in DVD drive 832 may send a digital signal through buffer 830 to encryptor/decryptor 828 for decryption. The decrypted signal then enters MPEG version of video watermark detector 834 where a search is performed for a watermark as described in foregoing FIGS. 5, 6 and 7. If the payload of the watermark permits the information on the disk to be transmitted, the signal then enters an AV decoder 836. The decoded signal then enters an output processor 840 for graphics processing and, in the case of an analog line out signal 842, digital to analog conversion. A digital signal out 814 would exit the output processor 840 after graphics processing and exit through the communications protocol gate 820 for MPEG encoding.

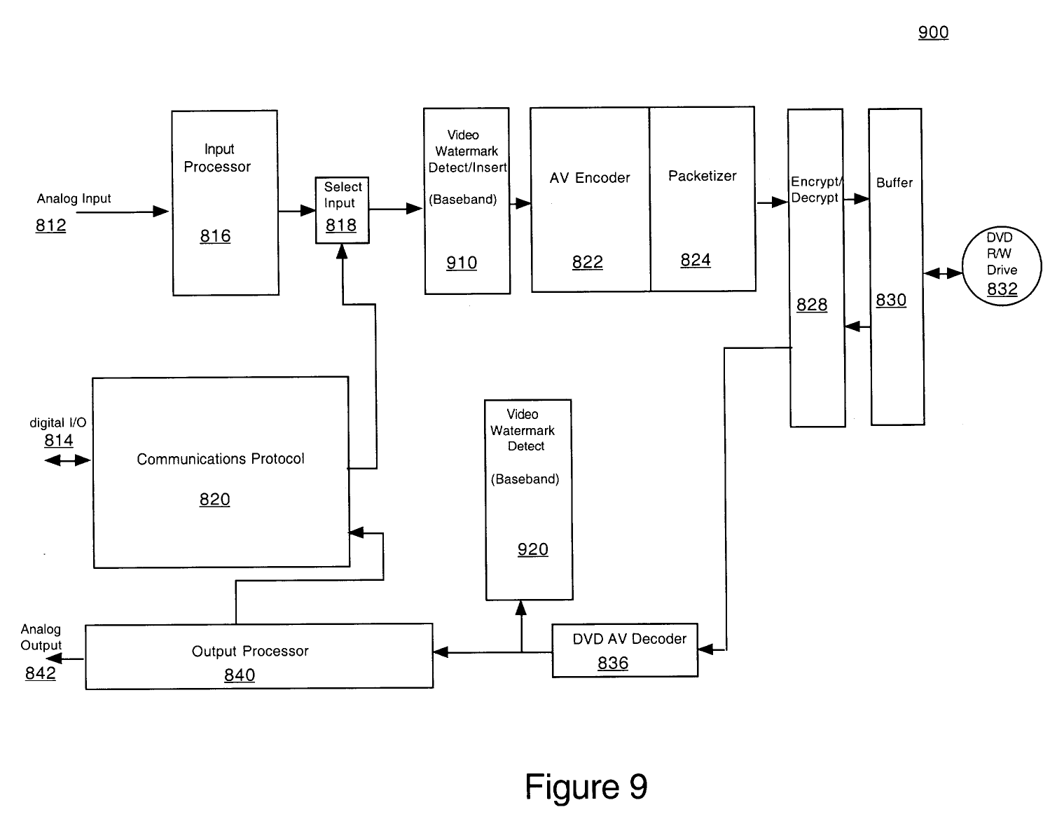

FIG. 9 depicts a block diagram of an exemplary DVD with a base-band inserter/detector upon which an embodiment of the present invention may be practiced. In the base-band version, the functional components are, in one embodiment, the same as those of the MPEG or bit stream domain version of FIG. 8. The primary difference is that, in the base-band version of FIG. 9, video watermark detector/inserter 910 is installed ahead of the AV encoder 822 so that a watermark may be detected and/or inserted in unencoded video. Also, the video watermark detector 920 is placed after the AV decoder 836 and the watermark may thus be detected in the unencoded state.

The foregoing descriptions of specific embodiments have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of detecting a watermark in a rotated video field, comprising:
a) correlating two video tiles in said rotated video field to determine relative positions of a watermark;
b) estimating an angle of rotation of said video field based on said relative positions;
c) rotating an expected watermark pattern by said estimated angle of rotation; and
d) using said rotated expected watermark pattern as input to a Symmetric Phase Only Match Filter system for watermark detection.

2. The method as described in claim 1, wherein said two video tiles are horizontally in-line.

3. The method as described in claim 1, wherein said two video tiles are vertically in-line.

4. The method as described in claim 1, wherein said rotating in said c) is in the spatial domain.

5. The method as described in claim 1, wherein said rotating in said c) is in the frequency domain.

6. The method as described in claim 1, wherein said angle of rotation of said rotated video field is within a visual tolerance level for a viewer.

7. The method as described in claim 1, wherein said detecting of said d) is performed in base-band video.

8. The method as described in claim 1, wherein said detecting of said d) is performed in converted bit stream domain.

9. The method as described in claim 1, wherein said Symmetric Phase Only Match Filter system of said d) accumulates a plurality of video tiles, one of said plurality of tiles per each of a plurality of video fields, each said one at a same location in said each of said plurality of video fields.

10. A method for estimating an angle of rotation in a rotated video field having a plurality of video tiles, each of said video tiles having an embedded watermark, said method comprising:
a) selecting a pair of video tiles;
b) determining a magnitude of a shift in one tile of said pair relative to the other; and
c) calculating said angle of rotation based on said magnitude of said shift and a pre-known width of said video tiles.

11. The method of claim 10 wherein said pair of video tiles is horizontally in-line.

12. The method of claim 11 wherein said shift is vertical.

13. The method of claim 10 wherein said pair of video tiles is vertically in-line.

14. The method of claim 13 wherein said shift is horizontal.

15. The method of claim 10 further comprising: d) rotating an expected watermark pattern, by said estimated angle of rotation for detecting watermarks in said rotated video field.

16. The method of claim 15, wherein said detecting is by a Symmetric Phase Only Match Filtering system.

17. The method of claim 15 wherein said expected watermark pattern is rotated in a spatial domain.

18. The method of claim 15 wherein said expected watermark pattern is rotated in a frequency domain.

19. A digital versatile disk comprising a processor, a plurality of devices and a video watermark inserter/detector, wherein said video inserter/detector comprises instructions for implementing a method of detecting a watermark in a rotated video field comprising:
a) correlating two video tiles in said rotated video field to determine relative positions of a watermark;
b) estimating an angle of rotation of said video field based on said relative positions;
c) rotating an expected watermark pattern by said estimated angle of rotation; and
d) using said rotated expected watermark pattern as input to a Symmetric Phase Only Match Filter system for watermark detection.

20. The digital versatile disk as described in claim 19, wherein said two video tiles are horizontally in-line.

21. The digital versatile disk as described in claim 19, wherein said two video tiles are vertically in-line.

22. The digital versatile disk as described in claim 19, wherein said rotating in said c) is in the spatial domain.

23. The digital versatile disk as described in claim 19, wherein said rotating in said c) is in the frequency domain.

24. The digital versatile disk as described in claim 19, wherein angle of rotation of said rotated video field is within a visual tolerance level for a viewer.

25. The digital versatile disk as described in claim 19, wherein said detecting of said d) is performed in base-band video.

26. The digital versatile disk as described in claim 19, wherein said detecting of said d) is performed in converted bit stream domain.
